(19) United States
(12) Patent Application Publication
(10) Pub. No.: US 2007/0232333 A1
(43) Pub. Date: Oct. 4, 2007

(54) Method and system for providing work related information in a mobile environment

(75) Inventor: Tian Xu, Shanghai (CN)

Correspondence Address: KENYON & KENYON LLP, 1500 K STREET N.W., WASHINGTON, DC, 20005, US

(73) Assignee: SAP AG, Walldorf (DE)

(21) Appl. No.: 11/395,432

(22) Filed: Mar. 30, 2006

(51) Int. Cl. H04Q 7/20

(52) U.S. Cl. 455/466

(57) ABSTRACT

A method and apparatus for collecting work related information from a mobile employee. A mobile employee sends a short message by simply pressing one key on his mobile phone, the system of the present invention collects the geographic, time, work status and employee information of the mobile employee. A mobile employee sends a short message to a mobile employee information collector. An SMS message receiver receives the short message and sends a geographic information query to a geographic information pager, and an employee information query to an employee information pager. A data processing unit receives the short message, the geographic information and employee information of the mobile employee and triggers a workflow in a data management system. The workflow could be used for keeping time record, managing inventory, assigning tasks, etc.

### BACKGROUND

Mobile employees, like truck drivers and sales representatives, work off their company's site and keep moving. It is important for a company to have real-time information about mobile employees' locations and working status. For example, a truck driver travels around a large geographic area to pick up and deliver various kinds of goods. According to one available method, the truck driver keeps a written log when he arrives at a location, what he picks up or delivers, etc., and provides the record to his company sometime later. The company does not have real-time information about the truck driver's location and working status. If something needs to be picked up from or delivered to a location urgently, the manager of the truck driver has to contact all drivers who might be around that location.

In another example, a sales representative visits a number of retail stores each day to promote new products and collect information about retail stores. According to an available method, the sales representative keeps a note of when he arrives a retail store, when he leaves a retail store, the inventory and volume of sales of various products of the retail store, etc. The sales representative then provides the notes to the management of his company. However, the management does not have real-time information about where the sales representative is, what he is working on and the status of the retail stores.

Thus, it would be desirable to introduce a simple, convenient and cost effective solution to figure out the real-time geographic and working status information of mobile employees.

Specifically, it is preferable to provide a method and system which can collect and generate a comprehensive set of work related information about a mobile employee by a very simple operation, with currently available infrastructure and positioning service provided by wireless telecommunication network operators, and without significant software and hardware investment.

### BRIEF DESCRIPTION OF THE DRAWINGS

FIG. 1 illustrates a block diagram of a mobile employee information collector according to an embodiment of the present invention.

FIG. 2 illustrates a flowchart of a method for collecting work related information of mobile employee according to an embodiment of the present invention.

### DETAILED DESCRIPTION

The present invention provides a system and method for collecting work related information of mobile employees. A mobile employee sends a short message by simply pressing a key on his mobile phone. The system may collect geographic, time, work status information of the mobile employee from the wireless telecommunication network and employee information from an internal database of the employer of the mobile employee, all of which may be stored by the system. The system also may trigger a work flow in the data manage system of the employer.

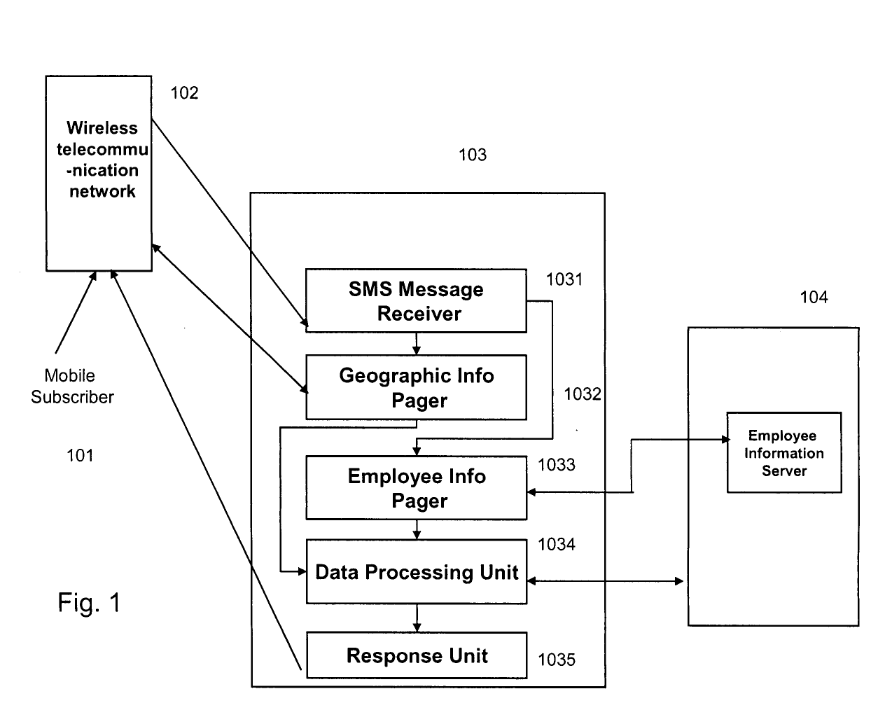

FIG. 1 illustrates a block diagram of a mobile employee information collector according to an embodiment of the present invention.

A mobile employee 101 is a subscriber of a wireless telecommunication network 102 which provides the SMS service. He sends a short message to an information collector 103 when he arrives at a new location and at other significant events that may occur during the course of his activities (e.g., departures, arrivals, refueling, breaks, equipment malfunctions, etc).

The wireless telecommunication network 102 could be a network using any type of wireless telecommunication technology, such as TDMA, GSM, CDMA, GPRS, 3G, etc. The network may support the very popular Short Message Service (SMS) provided by wireless telecommunication systems. The wireless telecommunication network 102 may forward the short message from the mobile employee 101 to a mobile employee information collector 103, together with an identifier of the sender (e.g., his phone number) of the short message and the sending time of the short message. The wireless telecommunication network 102 also could forward location information of the mobile employee to the information collector 103 in response to a geographic information query from the information collector 103. The wireless telecommunication network 102 could forward the short message and the geographic information via an email, for example.

In one embodiment, the mobile employee information collector 103 may have an SMS message receiver 1031 for receiving short messages; a geographic information pager 1032 for obtaining geographic information of the mobile employee; an employee information pager 1033 for obtaining employee information of the mobile employee; a data processing unit 1034 for processing the short message, the geographic information, the sending time of the short message, and the employee information and triggering a workflow in a data management system 104; and a response unit 1035.

The SMS message receiver 1031 receives the short message and associated phone number forwarded by the wireless telecommunication network 102. The SMS message receiver 1031 may obtain the sender's phone number, and may send an employee information query to the employee information pager 1033. The SMS message receiver 1031 also may send a geographic information query to the geographic information pager 1032. The mobile employee information collector 103 could be a software program or a circuit that could receive and process short message signals and interact with the wireless telecommunication network and a data management system.

The geographic information pager 1032 may receive the geographic information query and phone number of the mobile employee 101 from the SMS message receiver 1031. The geographic information pager 1032 may obtain the geographic information of the mobile employee by sending a request to the wireless communication network 102, and forwards the employee's geographic information to the data processing unit 1034.

The employee information pager 1033 may obtain the employee information by sending a request to an employee information server in the data management system 104. The employee information could be, for example, the employee's name, employee identification number, payroll account, the working group he belongs to, etc. The employee information pager 1033 may forward the employee information to the data processing unit 1034.

The data processing unit 1034 may pass the short message, employee information, the sending time of the short message, and geographic information to the data management system 104, which may trigger data processing procedure in the data management system 104. In one embodiment, the data processing unit 1034 stores a plurality of short codes and the information they represent, e.g., task and status. In one embodiment, for example, when receiving a short message including a code “A”, the data processing unit 1034 outputs the mobile employee's working status as arriving a retail store. In another example, when receiving a short message including a code “sl”, the data processing unit 1034 outputs the mobile worker's attendance status as sick leave. In a further example, when receiving a short message including a code “1”, the data processing unit 1034 outputs the mobile worker's task as loading.

The data processing unit 1034 may receive feedback from the data management system 104. Consequently, the response unit 1035 may send an SMS notification to the wireless telecommunication network, which forwards the SMS to the mobile employee.

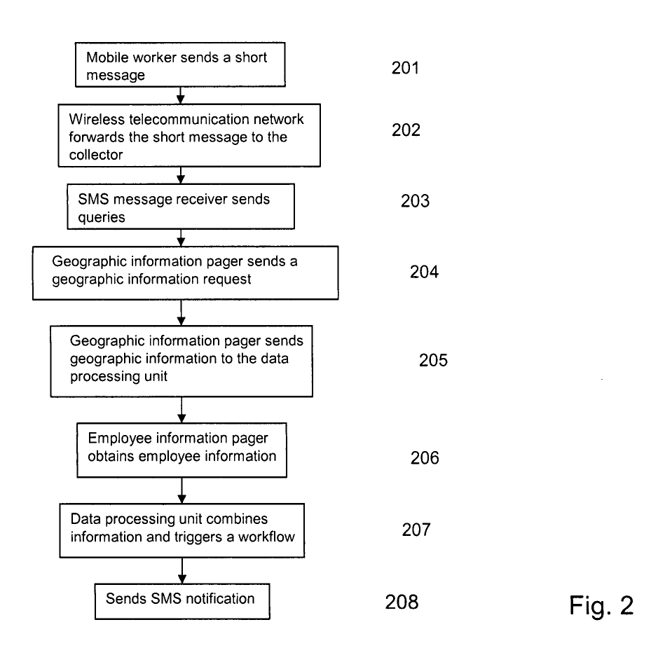

FIG. 2 illustrates a flowchart of a method for collecting work related information according to an embodiment of the present invention.

At 201, a mobile employee of a company, e.g., a truck driver or a sales representative, sends a short message to a telephone number designated for the company's mobile employee information collector. The mobile employee only needs to press keys of his mobile phone a few times to send the short message. In one embodiment, the mobile employee information collector may operate according to a coding system for input frequently used by the mobile employee. For example, “1” represents pick up, and “2” represents delivery. Consequently, if the mobile employee only wants to report the task, the short message includes one number or alphabet only. In another embodiment, the mobile employee could write a short message to provide more information about his working status. For example, the mobile employee could write “1, shampoo, 20 boxes”, which means he picked up 20 boxes of shampoo, or “2, coke, 50 boxes”, which means he delivered 50 boxes of coke. Further, the mobile employee could use a short code to report his attendance, for example, “54” for late, “sl” for sick leave, and “pl” for personal leave.

The mobile employee does not have to provide any location information. As discussed above, the wireless telecommunication network 102 may provide accurate geographic information to the mobile employee information collector. In one embodiment, the company's data management system 104 keeps a digital map, and could determine which store the mobile employee is at according to the geographic information from the telecommunication network. In another embodiment, wireless telecommunication network operators use signals from the freely available Global Positioning System (GPS) to provide the geographic information of the mobile employees, usually without charging users additional fees for the geographic information.

At 202, the wireless telecommunication network receives the short message from the mobile employee. The wireless telecommunication network forwards the short message, together with the telephone number of the sender and the sending time, to the mobile employee information collector. In one embodiment, the short message and associated information are forwarded by an email. In another embodiment, the wireless telecommunication network forwards the short message and associated information just like the mobile employee information collector is another SMS service subscriber.

At 203, the SMS message receiver 1031 receives the short message and associated information from the wireless telecommunication network, sends a geographic information query to the geographic information pager 1032, and an employee information query to the employee information pager 1033.

At 204, the geographic information pager 1032 sends a geographic information request to the wireless telecommunication network 102.

At 205, the geographic information pager receives the geographic information about the sender of the short message from the wireless telecommunication network, and sends the geographic information to the data processing unit 1034 together with the sender's telephone number.

At 206, the employee information pager 1033 sends a request to the company's data management system 104 in response to the employee information query from the SMS message receiver 1031, obtains the employee information of the mobile employee, and forwards the employee information to the data processing unit 1034. The employee information could be, for example, the employee's name, employee ID number, payroll account, the working group he belongs to, the projects he is working on, etc. In one embodiment, the data management system is mySAP™ ERP, and the employee information is obtained from the Address Book module of the mySAP™ ERP.

At 207, the data processing unit 1034 receives the geographic information of the mobile employee from the geographic information pager 1032, and the employee information from the employee information pager 1033. The short message, the sender's phone number and the sending time could be forwarded to the data processing unit from the SMS message receiver 1031 directly, or from the geographic information pager 1032 with the geographic information, or from the employee information pager 1033 with the employee information. The data process unit then combines the short message, the sending time, and the employee's geographic information and employee information, and sends the combined information to the data management system 104 to trigger a workflow.

The workflow could be used to, for example, keep the time record of the mobile employee, so that his manager knows when the mobile employee is working, when he is not, just like a punch card machine for employees working in an office building. The manager could get real time information about how much time the mobile employee spends on each project. The time record is based on information from the mobile employee information collector 103, such as the sending time of the short message, the task the mobile employee is carrying out, and the geographic information of the mobile employee.

The workflow could be used for transportation status monitoring, so that the manager of the mobile employee knows where the mobile employee is. If there is an urgent pick up or delivery request, the manager may identify a mobile employee that is close to that area and could assign the task to that mobile employee.

The data workflow could also be used for inventory management. For example, the short message from the mobile employee indicates that he has delivered 50 boxes of coke and 30 boxes of shampoo, the inventory manager will get such information immediately, and order more if necessary.

In one embodiment, a sales representative visits a store. He sends a short message indicating that he has arrived a store, for example by sending a code “A” in a short message. The mobile employee information collector 103 collects the short message, the sending time of the short message, the geographic information of the sales representative from the wireless telecommunication network, and employee information from the data management system 104 of the employer of the sales representative. The mobile worker information collector can recognize that the code “A” represents that the mobile employee arrives a store. The management will have the real time information about where the sales representative is, when he arrives the store, and what he is doing. All the sales representative needs to do is to press a key on his mobile phone. The sales representative sends a code “L” in another short message before he leaves the store. Then the management will have the real time information about how long the sales representative works in the store. The sales representative could also include some information about the store in his short message, for example, the store has only ten boxes of coke remaining. At the same time, the inventory manager could ask a truck driver to delivery 50 boxes of coke to that store as soon as possible.

If it is necessary, the data management system 104 will send a feedback message to the data processing unit 1034, the data processing unit 1034 will forward the feedback message to a response unit 1035, and the response unit 1035 will send a SMS notification to the mobile employee via the wireless telecommunication network.

While the invention has been described in detail above with reference to some embodiments, variations within the scope and spirit of the invention will be apparent to those of ordinary skill in the art.

What is claimed is:

1. A method for providing work related information, comprising:
receiving a short message from an employee about a task over a wireless telecommunication network; and
triggering a workflow in a data management system in response to the short message, wherein the method further comprising identifying geographic information of the employee.

2. The method of claim 1, further comprising sending a request for the employee's geographic information to the wireless telecommunication network.

3. The method of claim 1, wherein the geographic information is received from the wireless telecommunication network via an email.

4. The method of claim 1, wherein the geographic information is provided by the Global Positioning System (GPS).

5. The method of claim 1, further comprising sending a request to the data management system for the employee's employee information.

6. The method of claim 5, further comprising combining the geographic information, the short message and its sending time, and the employee information.

7. The method of claim 1, wherein the short message is about the type of the task.

8. The method of claim 1, wherein the short message is a code representing information about the task.

9. The method of claim 1, wherein the short message is a code representing information about the employee's attendance.

10. The method of claim 1, wherein the mobile employee inputs content of the short message by pressing one key on a mobile phone keypad once.

11. The method of claim 1, further comprising sending an SMS notification message to the mobile employee via the wireless telecommunication network.

12. The method of claim 1, wherein the workflow is used to keep time record of the mobile employee.

13. The method of claim 1, wherein the workflow is used for inventory management.

14. The method of claim 1, wherein the workflow is used for task assignment.

15. A system for collecting work related information, comprising:
a mobile message receiving mechanism for receiving a short message from an employee about a task over a wireless telecommunication network;
a data processing unit for triggering a workflow in a data management system in response to the short message; and
a geographic information pager for sending a request for the employee's geographic information.

16. The apparatus of claim 15, wherein the data processing unit stores a plurality of short codes.

17. The apparatus of claim 15, further comprising an employee information pager for sending a request to the data management system for the employee's employee information.

18. The apparatus of claim 15, further comprising a response unit for sending an SMS notification message to the mobile employee via the wireless telecommunication network.

19. A method, comprising:
responsive to a message received from a user of a wireless network, querying the wireless network for information representing a location from which the wireless network received the message from the user; and
storing contents of the message and location information received from the wireless network in a log representing the activity.

20. The method of claim 19, wherein the message is received according to a protocol of a Short Message Service of the wireless network.
